(19) United States
(12) Patent Application Publication
(10) Pub. No.: US 2019/0042940 A1
(43) Pub. Date: Feb. 7, 2019

(54) INFORMATION PROCESSING APPARATUS AND COMPONENT ESTIMATION METHOD

(71) Applicant: FUJITSU LIMITED, Kawasaki-shi (JP)

(72) Inventors: Makoto Sakairi, Yokohama (JP); Serban Georgescu, London (GB)

(73) Assignee: FUJITSU LIMITED, Kawasaki-shi (JP)

(21) Appl. No.: 16/048,675

(22) Filed: Jul. 30, 2018

(30) Foreign Application Priority Data
Aug. 4, 2017 (JP) 2017-152033

(51) Int. Cl. G06N 3/08

(52) U.S. Cl. CPC G06N 3/08; G06Q 30/0283

(57) ABSTRACT

A component estimation method that is executed by a computer, includes, generating a first learning model based on image data of a component and transaction data of the component as a first set of teacher data, extracting a first feature vector of the component based on the first learning model, generating a second learning model based on specification of the component and transaction data of the component as a second set of teacher data, extracting a second feature vector of an estimation target component based on the first learning model and image data of the estimation target component, and estimating transaction data of the estimation target component based on the second learning model, the second feature vector of the estimation target component and a specification of the estimation target.

### CROSS-REFERENCE TO RELATED APPLICATION

This application is based upon and claims the benefit of priority of the prior Japanese Patent Application No. 2017-152033, filed on Aug. 4, 2017, the entire contents of which are incorporated herein by reference.

### FIELD

The embodiments discussed herein are related to an information processing apparatus and a component estimation method.

### BACKGROUND

In the related art, there has been known a component estimation system capable of ruling and estimating the price and delivery date of a component based on the shape feature and specification of the component. As used herein, the term “shape feature” refers to, for example, the number of holes, the number of chamfers, the number of folds, and the like, and the term “specification” refers to, for example, tolerance, material, production quantity, and the like.

However, in the component estimation system of the related art, for example, when estimating components having greatly different shapes from each other, it is necessary for a user to set shape features conforming to the shapes of the components and the specifications of the components each time. Therefore, the burden on the user may be increased, which may result in insufficient setting and insufficient estimation precision.

Related technologies are disclosed in, for example, Japanese Laid-Open Patent Publication No. 2005-025387.

### SUMMARY

According to an aspect of the embodiments, a component estimation method that is executed by a computer, includes, generating a first learning model based on image data of a component and transaction data of the component as a first set of teacher data, extracting a first feature vector of the component based on the first learning model, generating a second learning model based on specification of the component and transaction data of the component as a second set of teacher data, extracting a second feature vector of an estimation target component based on the first learning model and image data of the estimation target component, and estimating transaction data of the estimation target component based on the second learning model, the second feature vector of the estimation target component and a specification of the estimation target.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of the configuration of a component estimation system according to an embodiment;

FIG. 2A is a view illustrating an example of a process of creating a DL model according to an embodiment;

FIG. 2B is a view illustrating another example of the process of creating a DL model according to an embodiment;

FIG. 3A is a view illustrating an example of a process of creating an estimation learning model according to an embodiment;

FIG. 3B is a view illustrating another example of the process of creating an estimation learning model according to an embodiment;

FIG. 4 is a view illustrating an example of a data structure of teacher data according to an embodiment;

FIG. 5 is a view illustrating the relationship between an estimation learning model, a component shape category, a DL model, and an estimation target according to an embodiment;

FIG. 6 is a view illustrating an example of a process of estimating an estimation target component according to an embodiment;

FIG. 7 is a view illustrating an example of an automatic selection process of an estimation learning model according to an embodiment;

FIG. 8 is a view illustrating an example of the ranking of similarity in the automatic selection process according to an embodiment;

FIG. 9 is a view illustrating an example of a flow of a process of creating an estimation learning model according to an embodiment;

FIG. 10 is a view illustrating an example of a flow of a process of estimating an estimation target component according to an embodiment;

FIG. 11 is a view illustrating an example of a flow of a process of extracting a machining shape feature vector according to an embodiment;

FIG. 12 is a view illustrating an example of a flow of a process of converting image data into a machining shape feature vector according to an embodiment;

FIG. 13 is a view illustrating an example of a flow of a process of selecting an estimation learning model according to an embodiment;

FIG. 14 is a view illustrating an example of a flow of a process of calculating similarity of teacher data according to an embodiment; and

FIG. 15 is a view illustrating a computer that executes a component estimation program.

### DESCRIPTION OF EMBODIMENTS

Hereinafter, embodiments of a component estimation program, a component estimation system and a component estimation method disclosed in the present disclosure will be described in detail with reference to the drawings. It should be noted that the present disclosure is not limited by the disclosed embodiment. Further, the following embodiments may be used in proper combination unless contradictory.

### Embodiments

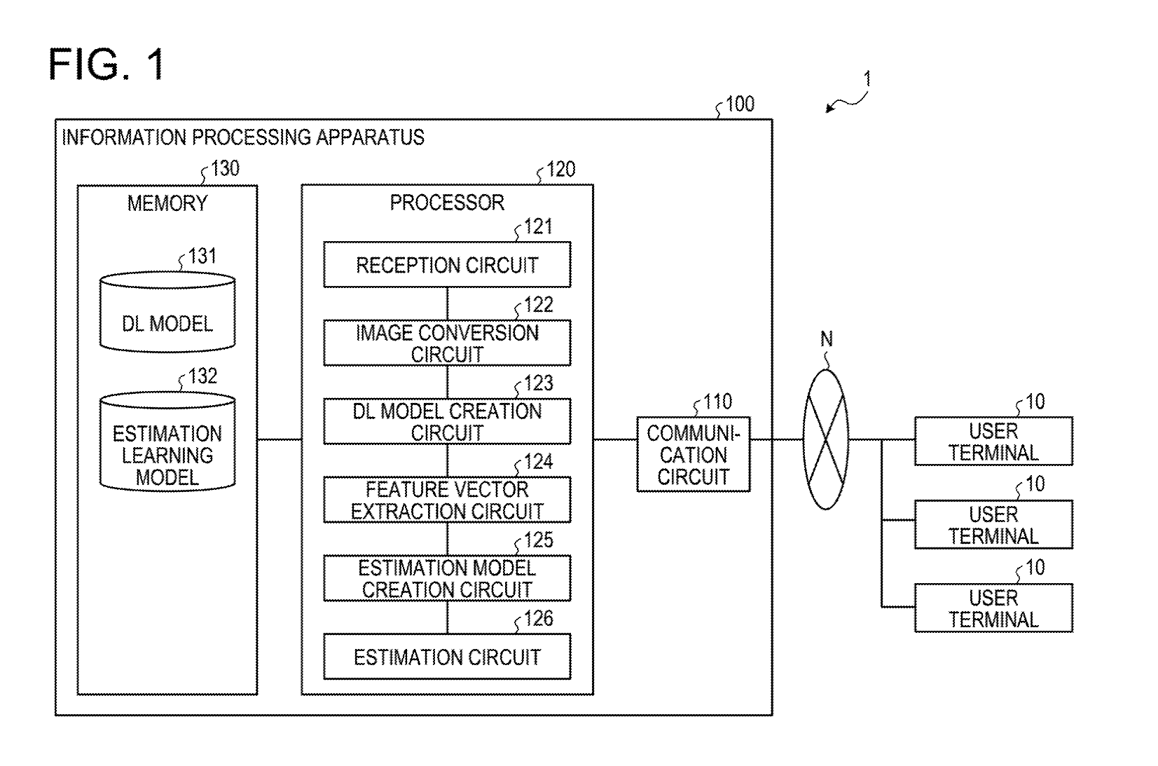

A component estimation system 1 according to an embodiment will be described with reference to FIG. 1. FIG. 1 is a functional block diagram illustrating an example of the configuration of a component estimation system according to an embodiment. The component estimation system 1 illustrated in FIG. 1 includes an information processing apparatus 100 and a plurality of user terminals 10. In this embodiment, the information processing apparatus 100 and the user terminals 10 are communicably connected via a wireless or wired network N. Note that the number of user terminals 10 in FIG. 1 is an example and the component estimation system 1 may be configured to include an arbitrary number of user terminals 10.

The user terminals 10 illustrated in FIG. 1 are used by device designers or the like. The device designers transmit information on the estimation of components used for devices to the information processing apparatus 100 through the user terminals 10.

The information processing apparatus 100 illustrated in FIG. 1 receives information on a component to be estimated (hereinafter also referred to as an estimation target component) from a user terminal 10 and outputs the result of estimation of the estimation target component. The information processing apparatus 100 according to this embodiment uses a model in which the shape features of various components, specifications of components, transaction data and the like are learned, to estimate a price and a delivery date based on the shape feature and specification of the estimation target component, thereby providing a useful estimation result.

[Functional Block]

Next, the functional configuration of the information processing apparatus 100 according to this embodiment will be described with reference to FIG. 1. The information processing apparatus 100 includes a communication circuit 110, a control circuit 120 and a memory 130.

Regardless of whether it is wired or wireless, the communication circuit 110 controls communication with the user terminals 10 and other computers. The communication circuit 110 is a communication interface such as an NIC (Network Interface Card) or the like.

The control circuit 120 is a processing unit that controls the overall operation of the information processing apparatus 100. The control circuit 120 is implemented by a CPU (Central Processing Unit), an MPU (Micro Processing Unit), a GPU (Graphics Processing Unit) or the like when a program stored in an internal memory device is executed with a RAM as a work area. Further, the control circuit 120 may be implemented by an integrated circuit such as an ASIC (Application Specific Integrated Circuit) or an FPGA (Field Programmable Gate Array).

The control circuit 120 includes a reception circuit 121, an image conversion circuit 122, a DL (Deep Learning) model creation circuit 123, a feature vector extraction circuit 124, an estimation learning model creation circuit 125 and an estimation circuit 126. Note that the reception circuit 121, the image conversion circuit 122, the DL model creation circuit 123, the feature vector extraction circuit 124, the estimation learning model creation circuit 125 and the estimation circuit 126 are examples of electronic circuits included in a processor or examples of a process executed by the processor.

The reception circuit 121 receives information on various components and an estimation target component from the user terminals 10 via the communication circuit 110. The information received by the reception circuit 121 is, for example, a 3D model, a specification, transaction data and the like of a component. Here, the 3D model is, for example, CAD data of the component, the specification includes, for example, tolerance, material, production quantity, etc., the transaction data includes, for example, price, delivery date and the like.

The image conversion circuit 122 converts the 3D model of various components and an estimation target component received by the reception circuit 121 into image data. For example, the image conversion circuit 122 converts the 3D model of the component into a plurality of pieces of image data viewed from various orientations.

The DL model creation circuit 123 creates a DL model 131 based on the image data obtained by the image conversion circuit 122 and the transaction data of the component.

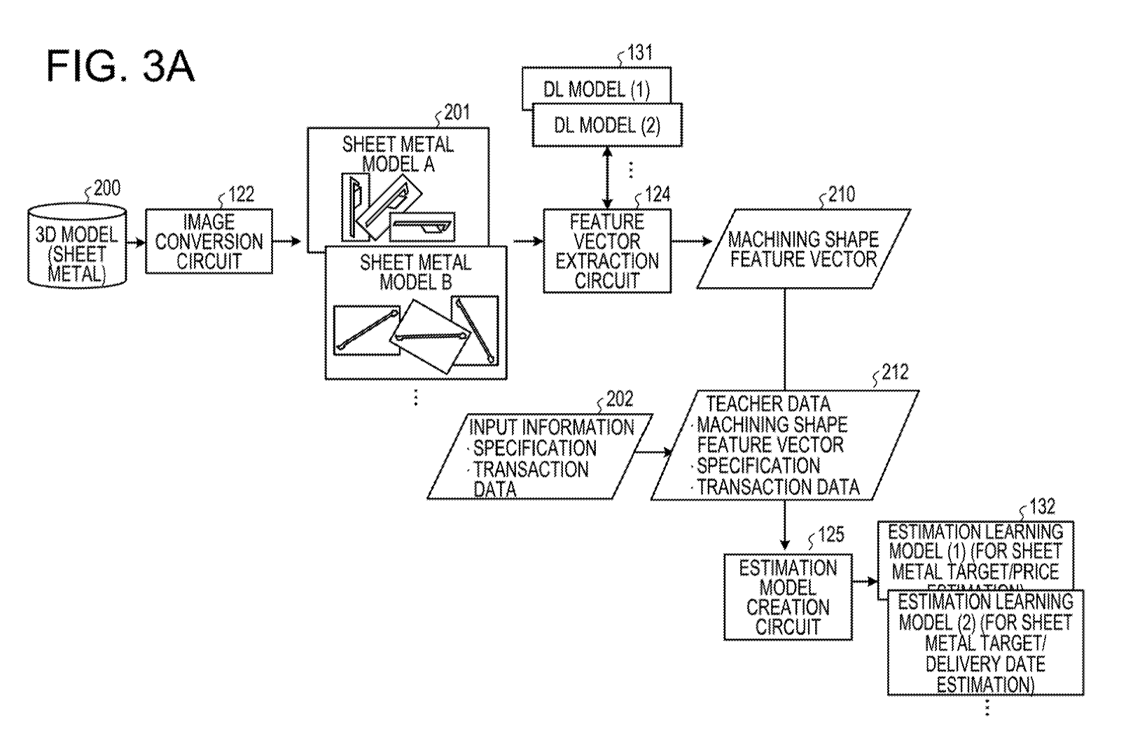

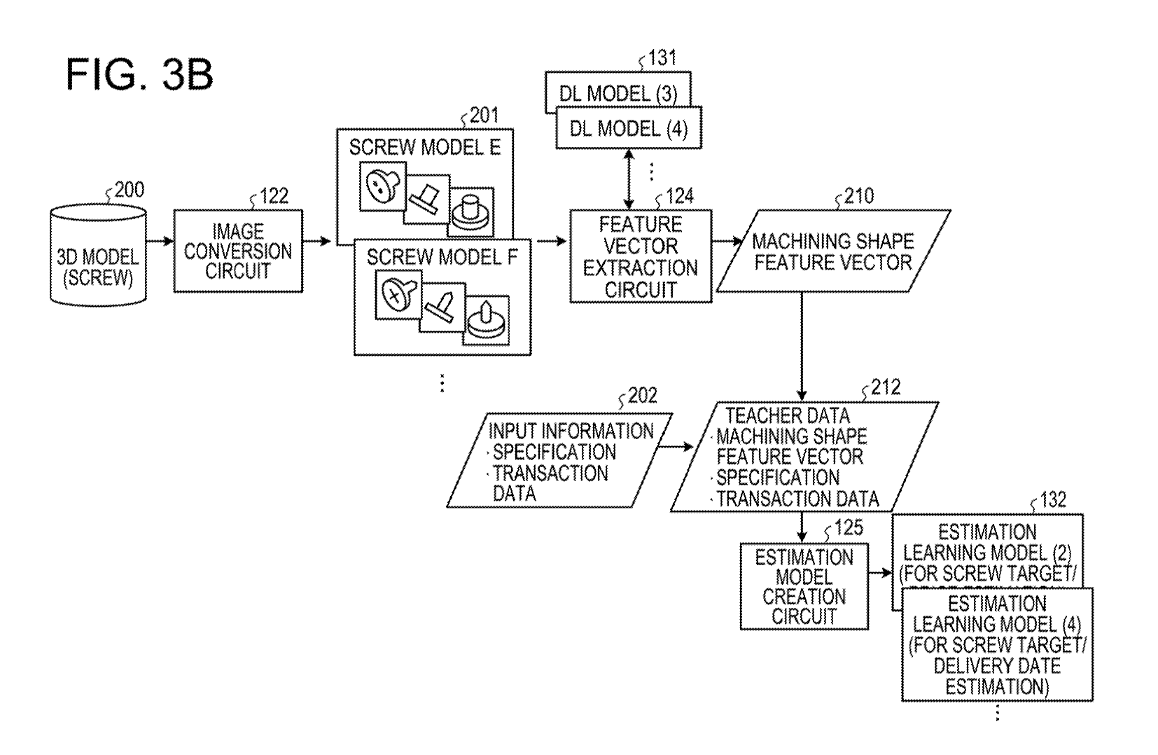

The feature vector extraction circuit 124 extracts a machining shape feature vector 210 (see FIG. 3A) of various components from the DL model 131 created by the DL model creation circuit 123. The machining shape feature vector 210 is an example of a feature vector.

The estimation learning model creation circuit 125 creates an estimation learning model 132 based on the machining shape feature vector 210 extracted by the feature vector extraction circuit 124 and the specifications and transaction data of various components.

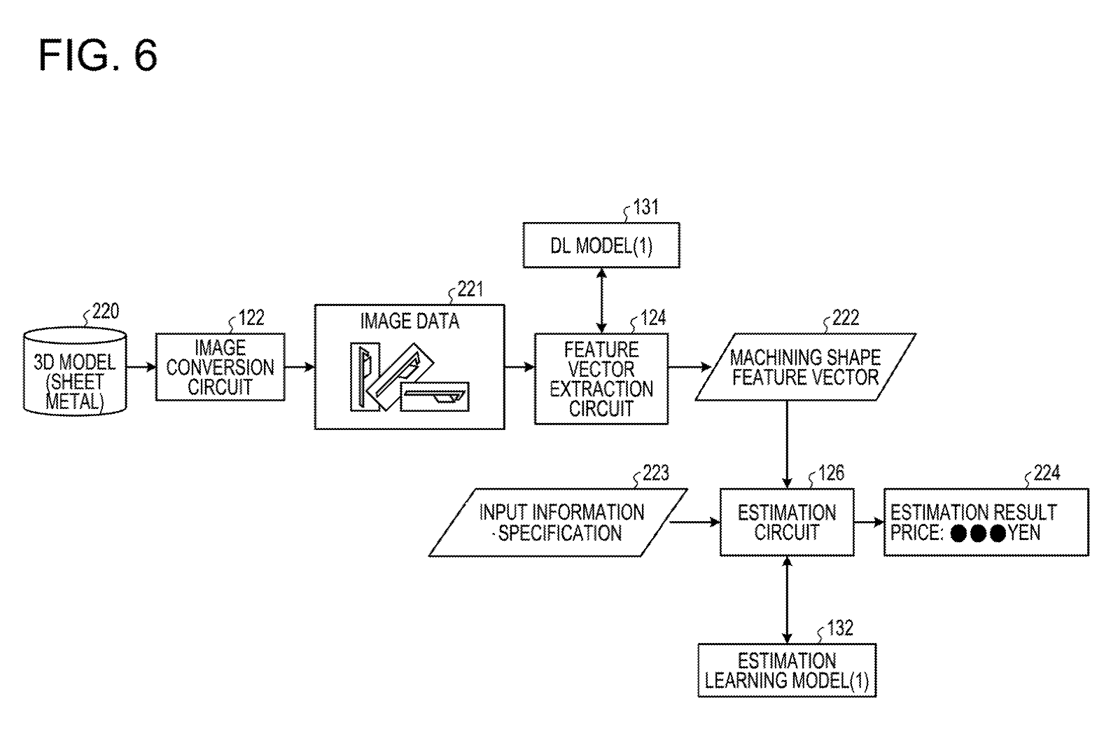

The estimation circuit 126 estimates the transaction data of the estimation target component based on the estimation learning model 132 created by the estimation learning model creation circuit 125, the machining shape feature vector 222 (see FIG. 6) of the estimation target component, and the specification of the estimation target component. Further, the estimation circuit 126 outputs information on the estimation result of the estimation target component to the user terminals 10.

The memory 130 stores, for example, various data such as programs executed by the control circuit 120. The memory 130 corresponds to a semiconductor memory device such as a RAM (Random Access Memory), a ROM (Read Only Memory), a flash memory or the like, or a storage device such as a HDD (Hard Disk Drive) or the like.

The memory 130 has the DL model 131 and the estimation learning model 132. The DL model 131 is an example of a first learning model and the estimation learning model 132 is an example of a second learning model.

The DL model 131 is a learning model used to calculate the machining shape feature vector 210 from the image data obtained by subjecting a 3D model of various components to an image conversion process. The estimation learning model 132 is a learning model used to estimate the estimation target component from the image data obtained by subjecting a 3D model of the estimation target component to an image conversion process.

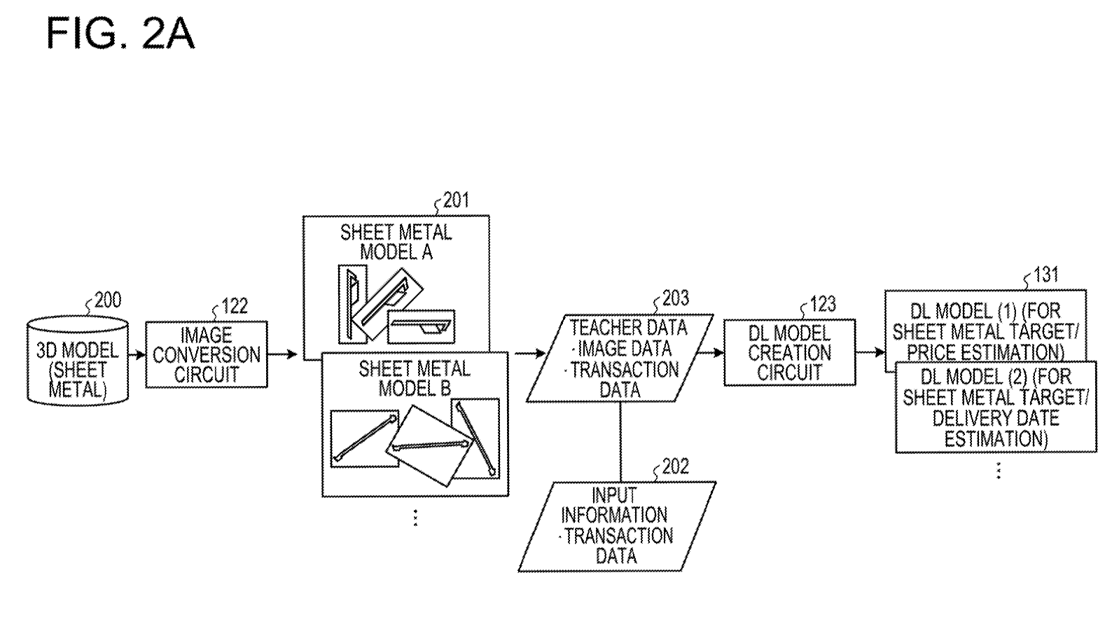

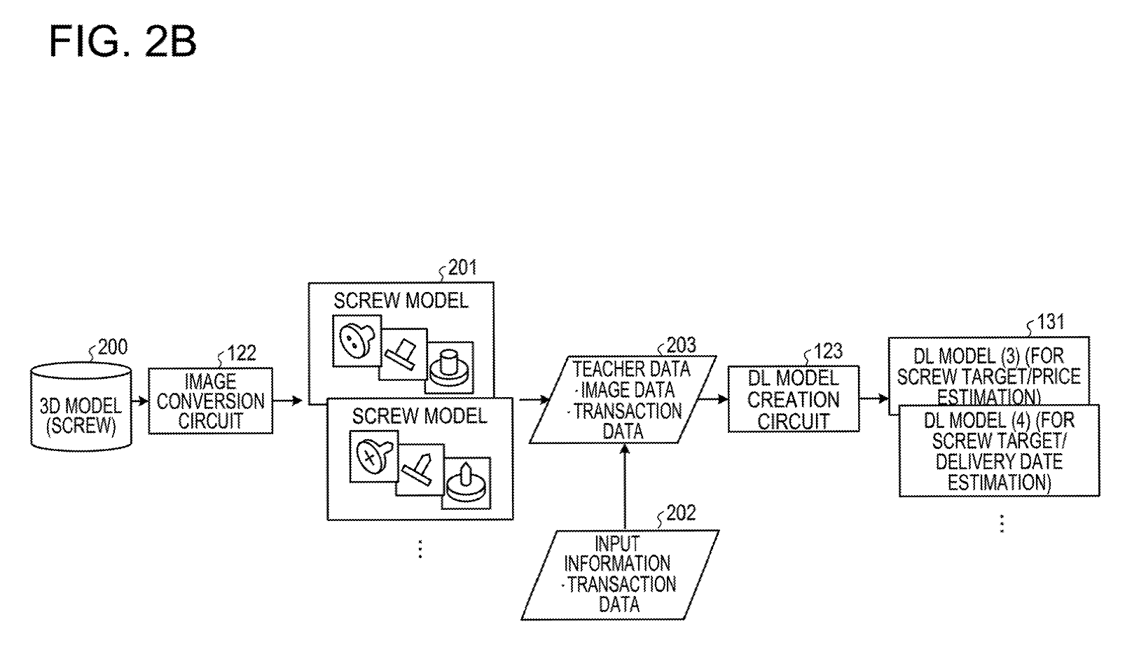

FIG. 2A is a view illustrating an example of a process of creating a DL model according to the embodiment. As illustrated in FIG. 2A, a sheet metal 3D model 200 received by the reception circuit 121 is subjected to a predetermined image conversion process by the image conversion circuit 122 to convert the sheet metal 3D model 200 into a plurality of pieces of image data 201 viewed from various orientations. For example, as illustrated in FIG. 2A, a 3D model 200 of a sheet metal model A is converted into a plurality of pieces of image data 201 and a 3D model 200 of a sheet metal model B is converted into another plurality of pieces of image data 201.

Next, the DL model creation circuit 123 stores in the memory 130 teacher data 203 associating the sheet metal image data 201 obtained in the image conversion circuit 122 with transaction data of sheet metal included in input information 202 separately input from the user terminals 10. Then, the DL model creation circuit 123 uses the teacher data 203 to execute a so-called deep learning using a multilayered deep layer neural network as a model. Thus, the DL model creation circuit 123 creates a plurality of DL models 131. For example, as illustrated in FIG. 2A, the DL model creation circuit 123 creates a DL model (1) for price estimation for sheet metal, a DL model (2) for delivery estimation for sheet metal, and the like.

FIG. 2B is a view illustrating another example of the process for creating a DL model according to the embodiment. As illustrated in FIG. 2B, a screw 3D model 200 received by the reception circuit 121 is subjected to a predetermined image conversion process by the image conversion circuit 122 to convert the screw 3D model 200 into a plurality of pieces of image data 201 viewed from various orientations. For example, as illustrated in FIG. 2B, a 3D model 200 of a screw model E is converted into a plurality of pieces of image data 201 and a 3D model 200 of a screw model F is converted into another plurality of pieces of image data 201.

Next, the DL model creation circuit 123 stores in the memory 130 teacher data 203 associating the screw image data 201 obtained in the image conversion circuit 122 with transaction data of screw included in input information 202 separately input from the user terminals 10. Then, the DL model creation circuit 123 uses the teacher data 203 to execute a deep learning. Thus, the DL model creation circuit 123 creates a plurality of DL models 131. For example, as illustrated in FIG. 2B, the DL model creation circuit 123 creates a DL model (3) for price estimation for screw, a DL model (4) for delivery estimation for sheet metal, and the like.

In this way, by creating the DL model 131 from the teacher data 203 associating the image data 201 of various components with the transaction data of such components, it is possible to learn a change in price, delivery date, etc. according to the shape of the components.

Further, in the embodiment, by executing the deep learning to create the DL model 131, it is possible to precisely extract the shape features of the components. Furthermore, in the embodiment, it is possible to extract the shape features of various components without requiring a user to set the shape features of the components. Therefore, according to the embodiment, the burden on the user can be reduced.

Subsequently, a process of using the created DL model 131 to create the estimation learning model 132 will be described with reference to FIG. 3A. FIG. 3A is a view illustrating an example of a process of creating an 3o estimation learning model according to the embodiment.

As illustrated in FIG. 3A, a sheet metal 3D model 200 received by the reception circuit 121 is subjected to a predetermined image conversion process by the image conversion circuit 122 to convert the sheet metal 3D model 200 into a plurality of pieces of image data 201 viewed from various orientations. For example, as illustrated in FIG. 3A, a 3D model 200 of a sheet metal model A is converted into a plurality of pieces of image data 201 and a 3D model 200 of a sheet metal model B is converted into another plurality of pieces of image data 201.

Subsequently, the feature vector extraction circuit 124 extracts a sheet metal machining shape feature vector 210 based on the sheet metal image data 201 obtained in the image conversion circuit 122 and the above-described DL model 131. This sheet metal machining shape feature vector 210 is a vector with the extracted shape features of components. For example, when the number of features (the number of neurons) is set as a T element and the image data 201 is converted only in an R direction, this sheet metal machining shape feature vector 210 is a T×R vector.

Next, the estimation learning model creation circuit 125 stores in the memory 130 teacher data 212 associating the machining shape feature vector 210, the sheet metal specification included in input information 202 input separately from the user terminals 10, and sheet metal transaction data included in the input information 202. Then, the estimation learning model creation circuit 125 uses the teacher data 212 to execute machine learning. An example of such machine learning may include SVM (Support Vector Machine) or the like. Thus, the estimation learning model creation circuit 125 creates a plurality of estimation learning models 132. For example, as illustrated in FIG. 3A, the estimation learning model creation circuit 125 creates an estimation learning model (1) for price estimation for sheet metal, an estimation learning model (2) for delivery estimation for sheet metal, and the like.

FIG. 3B is a view illustrating another example of the process of creating an estimation learning model according to the embodiment. As illustrated in FIG. 3B, a screw 3D model 200 received by the reception circuit 121 is subjected to a predetermined image conversion process by the image conversion circuit 122 to convert the screw 3D model 200 into a plurality of pieces of image data 201 viewed from various orientations. For example, as illustrated in FIG. 3B, a 3D model 200 of a screw model E is converted into a plurality of pieces of image data 201 and a 3D model 200 of a screw model F is converted into another plurality of pieces of image data 201.

Subsequently, the feature vector extraction circuit 124 extracts a screw machining shape feature vector 210 based on the screw image data 201 obtained in the image conversion circuit 122 and the above-described DL model 131. Next, the estimation learning model creation circuit 125 stores in the memory 130 teacher data 212 associating the machining shape feature vector 210, the screw specification included in input information 202 input separately from the user terminals 10, and screw transaction data included in the input information 202. Then, the estimation learning model creation circuit 125 uses the teacher data 212 to execute machine learning such as SVM or the like. Thus, the estimation learning model creation circuit 125 creates a plurality of estimation learning models 132. For example, as illustrated in FIG. 3B, the estimation learning model creation circuit 125 creates an estimation learning model (3) for price estimation for screw, an estimation learning model (4) for delivery estimation for screw, and the like.

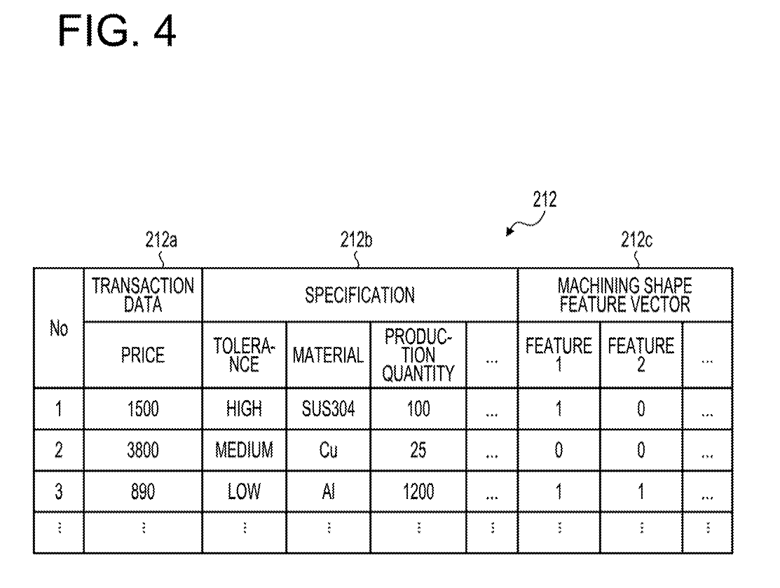

FIG. 4 is a view illustrating an example of a data structure of teacher data according to the embodiment. As illustrated in FIG. 4, the teacher data 212 includes transaction data 212a, the specification 212b and a machining shape feature vector 212c in association with each other. The transaction data 212a is, for example, a price, but it is not limited thereto but may be transaction data (for example, delivery date, etc.) of components. The transaction data 212a is also used as a label of the teacher data 212. The specification 212b includes, for example, tolerance, material, production quantity, etc. of components. However the specification is not limited thereto but may be any component specification. The machining shape feature vector 212c is, for example, Feature 1, Feature 2, . . . , Feature X (X is a positive number) that represent various component features. This machining shape feature vector 212c corresponds to the above-described machining shape feature vector 210.

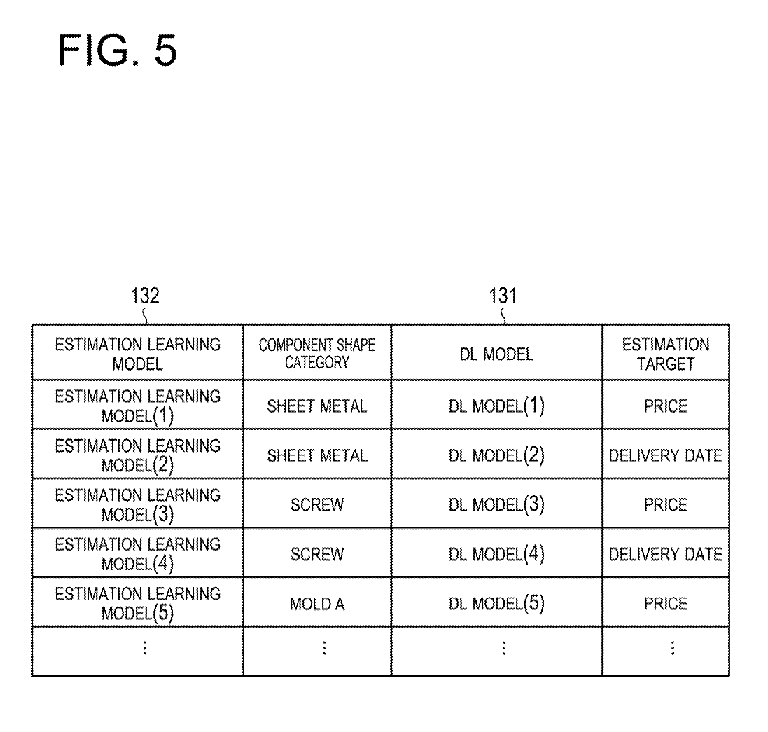

FIG. 5 is a view illustrating a relationship between an estimation learning model, a component shape category, a DL model and an estimation target. As illustrated in FIG. 5, for example, when the estimation learning model 132 is the “estimation learning model (1)”, “sheet metal” corresponds to the component shape category, “DL model (1)” corresponds to the DL model 131, and price” corresponds to the estimation target. When the estimation learning model 132 is the “estimation learning model (2)”, “sheet metal” corresponds to the component shape category, “DL model (2)” corresponds to the DL model 131, and “delivery date” corresponds to the estimation target. In this manner, the estimation learning model 132, the component shape category, the DL model 131 and the estimation target are all in the one-to-one correspondence.

Subsequently, a process of using the estimation learning model 132 to estimate estimation target component will be described with reference to FIG. 6. FIG. 6 is a view illustrating an example of a process of estimating estimation target component according to the embodiment. As illustrated in FIG. 6, a 3D model 220 of sheet metal, which is estimation target component, received by the reception circuit 121 is subjected to a predetermined image conversion process by the image conversion circuit 122 to convert the 3D model 220 of the estimation target component into a plurality of pieces of image data 221 viewed from various orientations.

Next, the feature vector extraction circuit 124 extracts a machining shape feature vector 222 of the estimation target component based on the estimation target component image data 221 obtained in the image conversion circuit 122 and a DL model 131 (for example, the DL model (1)) adapted to the estimation target component.

Next, the estimation circuit 126 calculates an estimation result 224 of the estimation target component based on the extracted machining shape feature vector 222, the specification of the estimation target component, and an estimation learning model 132 (for example, the estimation learning model (1)) adapted to the estimation target component. The specification of the estimation target component is included in input information 223 input separately from the user terminals 10.

As described above, in the embodiment, at the first stage, the teacher data 203 associating the component shape features with the component transaction data with each other is used to create the DL model 131. In the next step, the teacher data 212 associating the machining shape feature data 210 whose features are extracted based on the created DL model 131, the component specification and the component transaction data is used to create the estimation learning model 132. Finally, the estimation target component is estimated based on the created estimation learning model 132.

Here, it is assumed that deep learning is executed using teacher data associating image data of various components, the specifications of such components and transaction data of components with each other and a learning model for estimation is created directly (that is, in one step). In this case, if the image data is the same, the specifications of the components are the same and only the quantity is different, a price which is a label of the teacher data will be different, but which a deep neural network differs depending on which label (price) is a correct answer. Therefore, in this case, it is difficult to make precise estimation.

In the meantime, in the embodiment, it is possible to create a highly precise learning model by creating a learning model (estimation learning model 132) for estimation by two-step machine learning. Therefore, according to the embodiment, it is possible to precisely estimate the estimation target component.

As illustrated in FIG. 5, in the embodiment, it is possible to improve the precision of estimation by creating a DL model 131 and an estimation learning model 132 suitable respectively for the component shape category and the component estimation target. Here, in the process of estimating the estimation target component illustrated in FIG. 6, there are the following three methods for selecting a DL model 131 and an estimation learning model 132 suitable for the estimation target component.

(1) A user selects.

(2) The information processing apparatus 100 selects based on the shape category of the estimation target component selected by the user and the estimation target.

(3) The information processing apparatus 100 selects automatically.

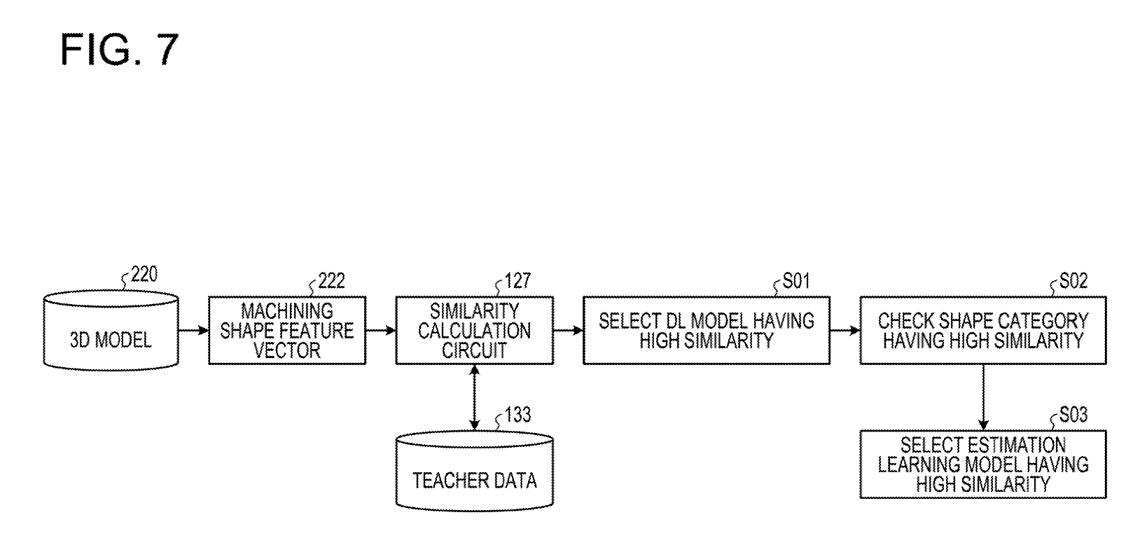

Next, among these three methods, a process by the information processing apparatus 100 to automatically select a DL model 131 and an estimation learning model 132 will be described with reference to FIG. 7. FIG. 7 is a view illustrating an example of a process of automatically selecting an estimation learning model according to the embodiment.

When such an automatic selecting process is performed by the information processing apparatus 100, a similarity calculation circuit 127 is additionally provided in the control circuit 120 of the information processing apparatus 100 and a teacher data DB 133 is separately stored in the memory 130. The teacher data DB 133 is a database in which all the teacher data 203 used for creating the DL model 131 illustrated in FIG. 2A are stored. Furthermore, the DL model 131 and the machining shape feature vector 210 associated with the respective each teacher data 203 are stored in the teacher data DB 133.

As illustrated in FIG. 7, the various above-described processes are performed in the image conversion circuit 122 and the feature vector extraction circuit 124 based on the 3D model 220 of sheet metal, which is the estimation target component, received by the reception circuit 121, to extract the machining shape feature vector 222 of the estimation target component. Subsequently, the similarity calculation circuit 127 calculates the similarity between the machining shape feature vector 222 of the estimation target component and the teacher data 203 stored in the teacher data DB 133. Then, the similarity calculation circuit 127 selects a DL model 131 associated with the teacher data 203 having high extracted similarity as a DL model 131 having high similarity (step S01).

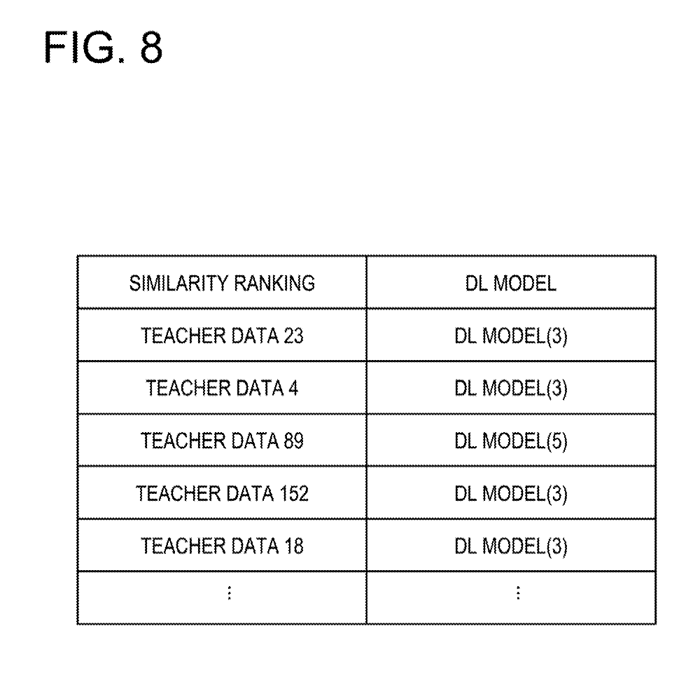

FIG. 8 is a view illustrating an example of the rank of similarity in the automatic selecting process according to the embodiment. For example, “DL model (3)” as the DL model 131 is associated with “teacher data 23” which is the teacher data 203 having the similarity of the first rank. “DL model (3)” as the DL model 131 is associated with “teacher data 4” which is the teacher data 203 having the similarity of the second rank. “DL model (5)” as the DL model 131 is associated with “teacher data 89” which is the teacher data 203 having the similarity of the third rank. Based on the teacher data 203 ranked in this way, a DL model 131 having high similarity is selected from the DL model 131 associated with the superior (for example, top 20 or top 50) teacher data 203.

Returning to FIG. 7, next, the similarity calculation circuit 127 checks a shape category having high similarity based on an estimation target (price, delivery date, etc.) set by a user at the time of estimation (step S02). Then, the similarity calculation circuit 127 selects an estimation learning model 132 having high similarity based on the shape category having high similarity and the DL model 131 having high similarity (step S03).

Through the automatic selecting process of the estimation learning model 132 described so far, it is possible for the user to select an estimation learning model 132 adapted to the estimation target component without special consciousness.

[Process Flow]

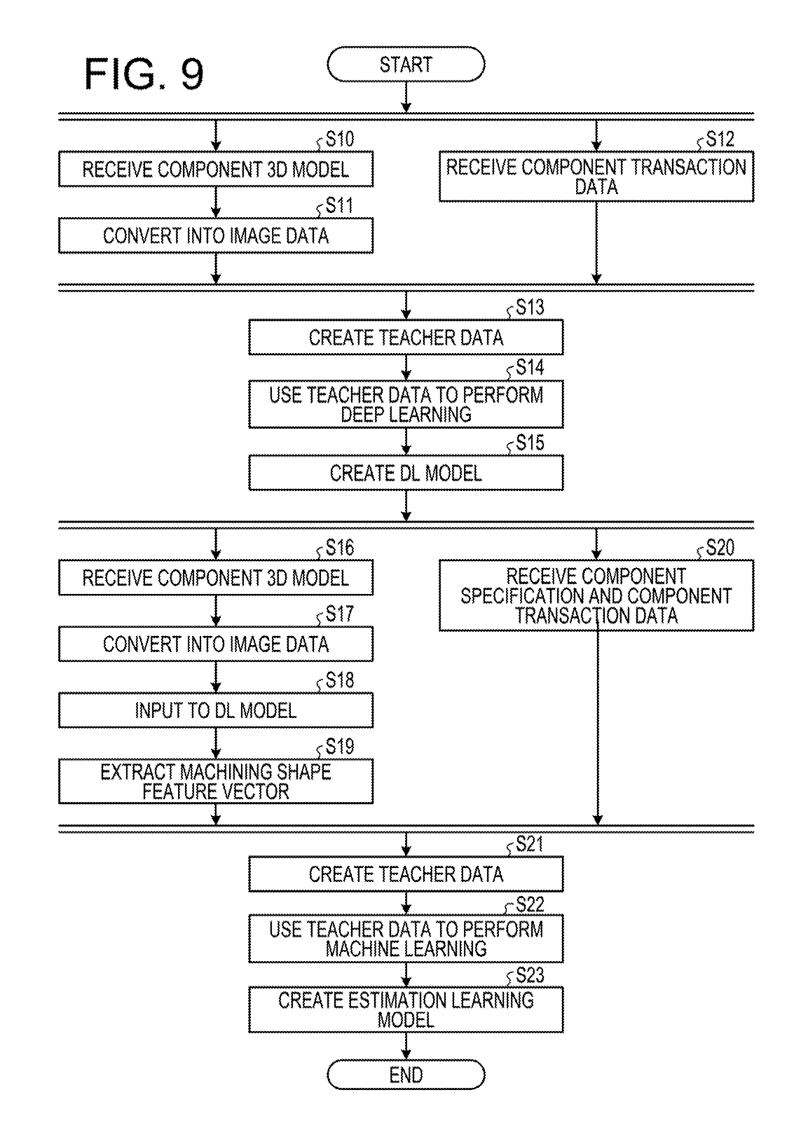

Next, flows of the various processes according to the embodiment will be described with reference to FIGS. 9 to 14. FIG. 9 is a view illustrating an example of a flow of the process of creating an estimation learning model according to the embodiment. As illustrated in FIG. 9, the reception circuit 121 receives 3D models 200 of various components (step S10). Subsequently, the image conversion circuit 122 converts the received component 3D models 200 into image data 201 (step S11). In parallel with steps S10 and S11, the reception circuit 121 receives transaction data of the various components (step S12).

Next, the DL model creation circuit 123 creates the teacher data 203 associating the image data 201 obtained in the image conversion circuit 122 with the component transaction data (step S13). Then, the DL model creation circuit 123 uses the teacher data 203 to perform deep learning (step S14). This deep learning is, for example, deep learning using a multilayered deep neural network as a model. Through such deep learning, the DL model creation circuit 123 creates the DL model 131 (step S15).

Next, the reception circuit 121 receives 3D models 200 of various components (step S16). Subsequently, the image conversion circuit 122 converts the received component 3D models 200 into image data 201 (step S17). Next, the feature vector extraction circuit 124 inputs the obtained image data 201 to the DL model 131 created in step S15 (step S18) and extracts the machining feature vector 210 (step S19). In parallel with steps S16 to S19, the reception circuit 121 receives the specifications and transaction data of various components (step S20).

Next, the estimation learning model creation circuit 125 creates the teacher data 212 associating the extracted machining shape feature vector 210, the component specification and the component transaction data with each other (step S21). Then, the estimation learning model creation circuit 125 uses the teacher data 212 to perform machine learning (step S22). This machine learning is, for example, SVM. Through such machine learning, the estimation learning model creation circuit 125 creates the estimation learning model 132 (step S23) and ends the process.

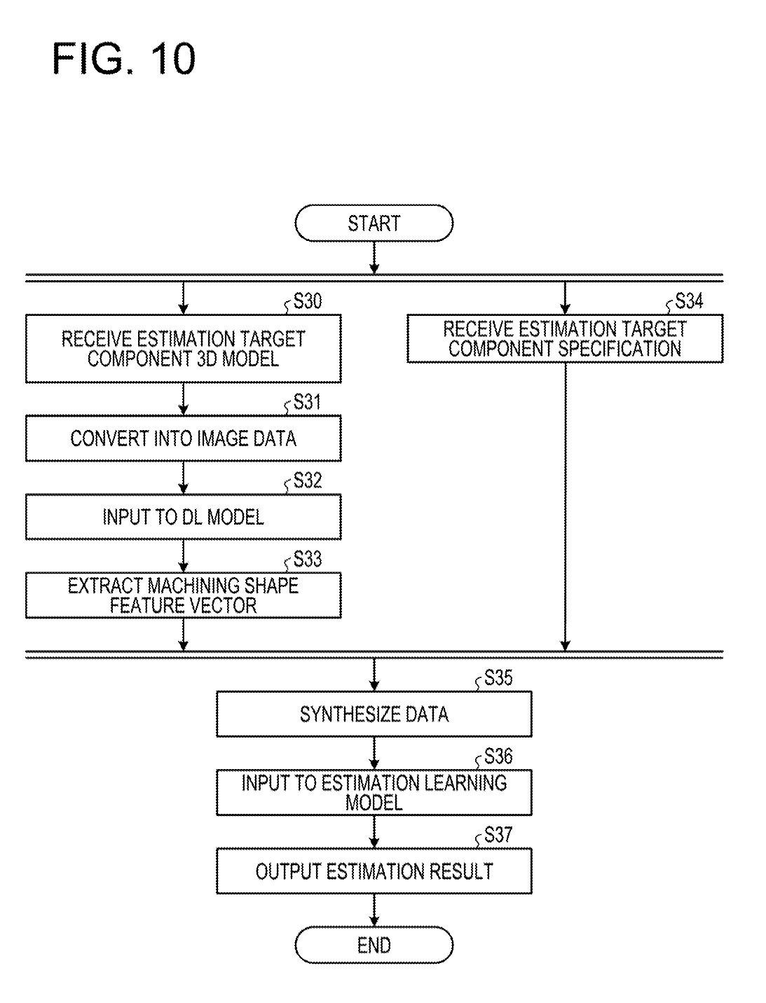

FIG. 10 is a view illustrating an example of a flow of the process of estimating estimation target component according to the embodiment. As illustrated in FIG. 10, the reception circuit 121 receives a 3D model 220 of the estimation target component (step S30). Subsequently, the image conversion circuit 122 converts the received estimation target component 3D model 220 into image data 221 (step S31). Next, the feature vector extraction circuit 124 inputs the obtained image data 221 to the DL model 131 adapted to the estimation target component (step S32) and extracts the machining shape feature vector 222 (step S33). In parallel with steps S30 to S33, the reception circuit 121 receives the specification of the estimation target component (step S34).

Next, the estimation circuit 126 synthesizes data on the extracted machining shape feature vector 222 and the estimation target component specification (step S35). Then, the estimation circuit 126 inputs the synthesized data to the estimation learning model 132 (step S36), outputs the estimation result (step S37), and ends the process.

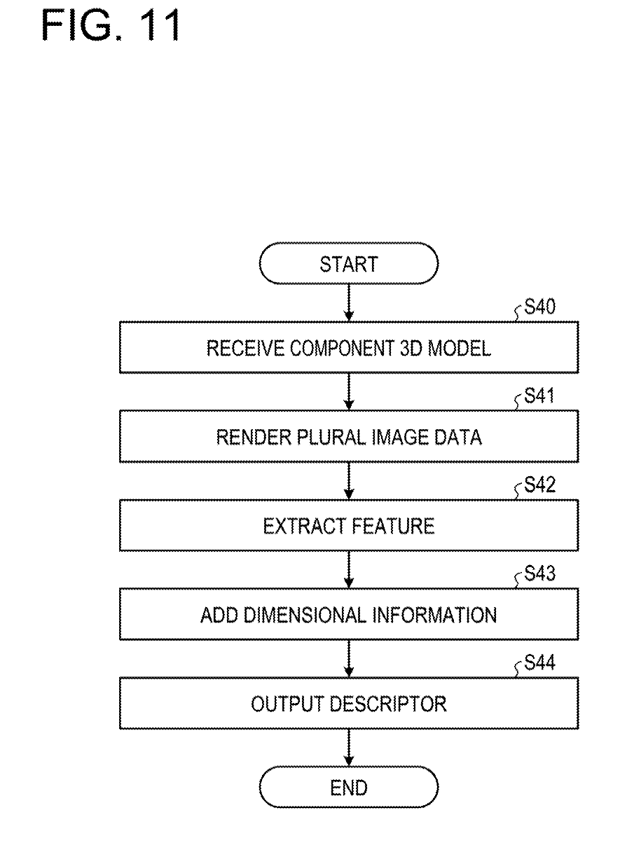

FIG. 11 is a view illustrating an example of a flow of the process of extracting a machining shape feature vector according to the embodiment. As illustrated in FIG. 11, the reception circuit 121 of the information processing apparatus 100 receives a component 3D model 200 (step S40). Next, the image conversion circuit 122 renders a plurality of pieces of image data 201 from the received 3D model 200 (step S41). Subsequently, the feature vector extraction circuit 124 uses a deep neural network to extract a feature from each rendered image data 201 (step S42). This feature corresponds to the machining shape feature vector 210. A process of extracting this feature amount will be described in detail later.

Next, the feature vector extraction circuit 124 adds a plurality of dimensional information related to the dimensions of objects (step S43). Then, the feature vector extraction circuit 124 outputs one 3D descriptor for the 3D model 200 in which all the machining feature vectors 210 of the 3D model 200 and the added dimensional information are combined (step S44), and ends the process.

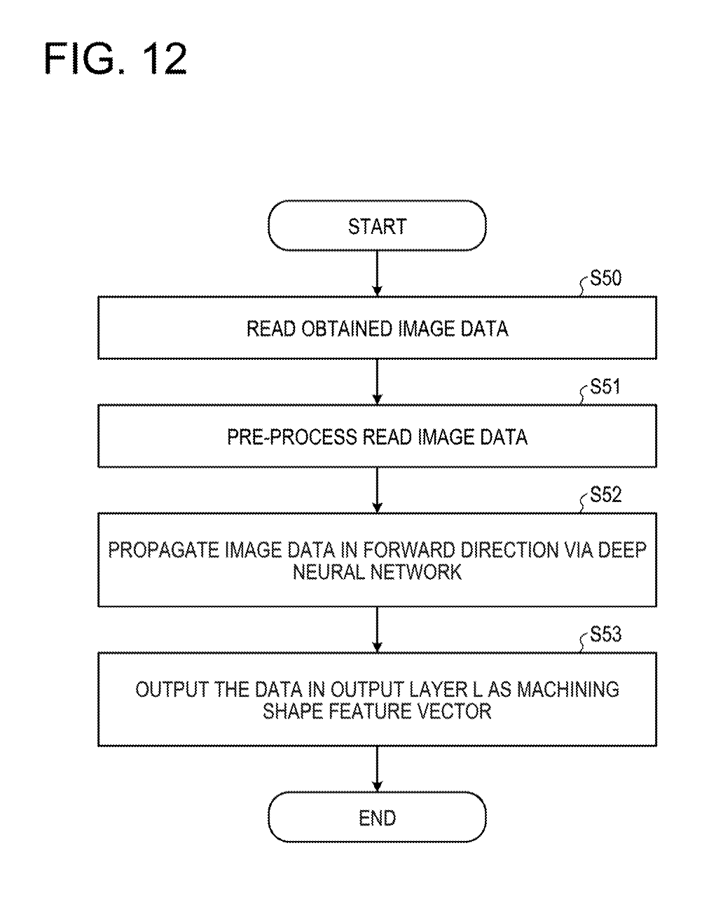

FIG. 12 is a view illustrating an example of a flow of the process of converting image data into a machining shape feature vector according to the embodiment. As illustrated in FIG. 12, the feature vector extraction circuit 124 of the information processing apparatus 100 reads image data 201 obtained in the image conversion circuit 122 (step S50). Subsequently, the feature vector extraction circuit 124 pre-processes the read image data 201 so that it is adapted to a deep neural network (step S51). Examples of such pre-processing may include rescaling, average extraction, color channel swapping, and the like.

Next, the feature vector extraction circuit 124 places the pre-processed image data 201 in an input layer of the deep neural network and propagates the image data 201 in a forward direction via the deep neural network until reaching an output layer L (step S52). Then, the feature vector extraction circuit 124 outputs the data in the output layer L as the machining shape feature vector 210 (step S53) and ends the process.

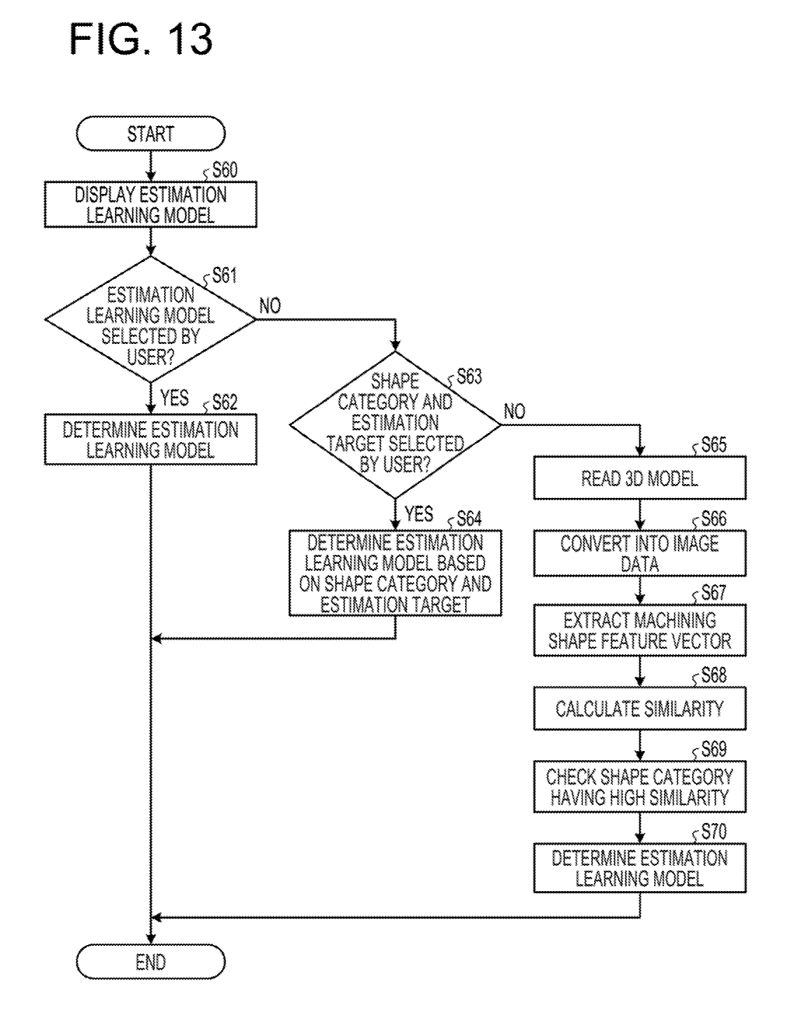

FIG. 13 is a view illustrating an example of a flow of the process of selecting an estimation learning model according to embodiment. As illustrated in FIG. 13, the information processing apparatus 100 displays all the estimation learning models 132 stored in the memory 130 as a list on a user terminal 10 of the user who has executed the process of estimating the estimation target component (step S60). Then, the information processing apparatus 100 causes the user to select an estimation learning model 132 suitable for the estimation target component from all the displayed estimation learning models 132 (step S61).

Here, when the user selects an estimation learning model 132 adapted to the estimation target component (Yes in step S61), the selected estimation learning model 132 is determined as an estimation learning model 132 adapted to the estimation target component (step S62) and the process is ended. For example, if the user selects “estimation learning model (3)” as the estimation learning model 132 adapted to the estimation target component, the information processing apparatus 100 determines that the “estimation learning model (3)” is the estimation learning model 132 adapted to the estimation target component.

In the meantime, when the user does not select an estimation learning model 132 adapted to the estimation target component (No in step S61), the information processing apparatus 100 causes the user to select an estimation target component shape category (for example, sheet metal or screw) and an estimation target (for example, price or delivery date) (step S63). This selecting process is performed, for example, by the information processing apparatus 100 displaying items to be selected by the user terminal 10 of the user.

Here, when the user selects an estimation target component shape category and an estimation target (Yes in step S63), the information processing apparatus 100 determines an estimation learning model 132 based on the selected estimation target component shape category and estimation target (step S64) and ends the process. For example, when the user selects “screw” as the estimation target component shape category and “price” as the estimation target, the information processing apparatus 100 determines “estimation learning model (3)” based on the “screw” and the “price” as an estimation learning model 132 adapted to the estimation target component.

In the meantime, when the user does not select an estimation target component shape category and an estimation target (No in step S63), the reception circuit 121 of the information processing apparatus 100 reads a 3D model 220 of the estimation target component (step S65). Next, the image conversion circuit 122 converts the read estimation target component 3D model 220 into image data 221 (step S66). Next, the feature vector extraction circuit 124 extracts a machining shape feature vector 222 from the image data 221 of the estimation target component (step S67). Next, the similarity calculation circuit 127 calculates the similarity between the extracted machining shape feature vector 222 of the estimation target component and the teacher data 203 stored in the teacher data DB 133 (step S68). Thus, the similarity calculation circuit 127 selects a DL model 131 associated with the teacher data 203 having extracted high similarity as a DL model 131 having high similarity.

Next, the similarity calculation circuit 127 checks a shape category having high similarity based on an estimation target (price, delivery date, etc.) set by the user at the time of estimation (step S69). Then, the similarity calculation circuit 127 determines an estimation learning model 132 having high similarity based on the shape category having high similarity and the DL model 131 with high similarity (step S70) and ends the process.

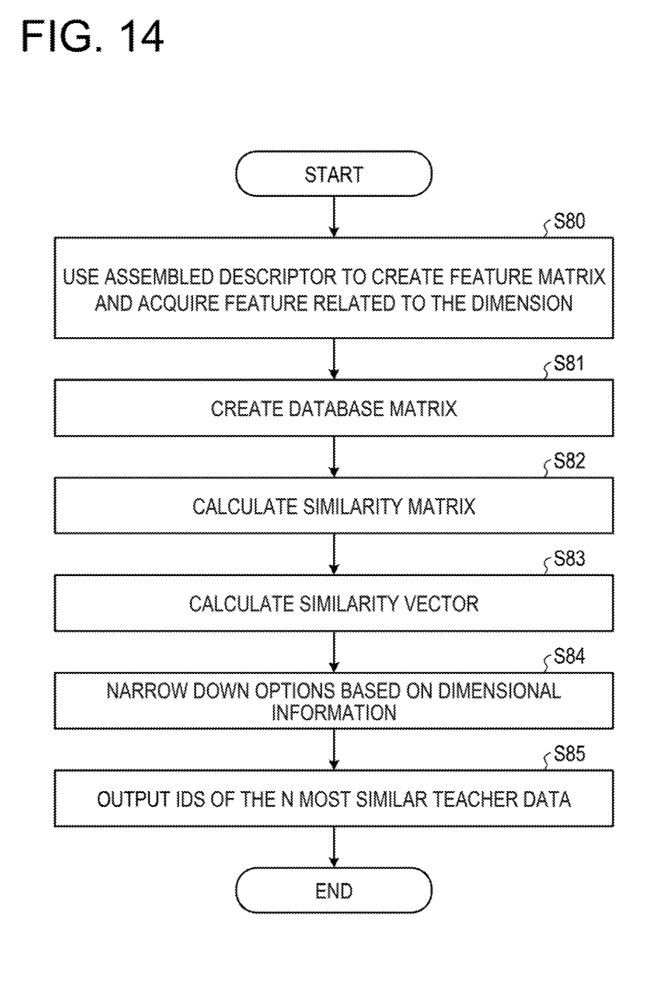

FIG. 14 is a view illustrating an example of a flow of the process of calculating the similarity of teacher data according to the embodiment. As illustrated in FIG. 14, the similarity calculation circuit 127 of the information processing apparatus 100 uses an assembled descriptor for the estimation target component to create a feature matrix fM to acquire a feature related to the dimension (step S80). The feature matrix fM has the same number of rows as the rendered image data 221 and the same number of columns as the feature in the machining shape feature vector 222. This information is extracted from an assembled descriptor of the estimation target component 3D model 220, for example, by a standard matrix shape change operation on continuous vectors forming a descriptor for presenting data in a matrix form. Here, when the assembled descriptor is stored in a matrix form, a shape change operation is not required to extract data for forming the feature matrix fM. In addition, the dimension information is extracted simply from the assembled descriptor.

Next, the similarity calculation circuit 127 creates a database matrix dM (step S81). This database matrix dM is created when the feature matrix fM for each teacher data 203 in the teacher data DB 133 is created and all rows of this feature matrix fM are added.

Next, the similarity calculation circuit 127 calculates a similarity matrix sM (step S82). Here, the similarity matrix sM is calculated by the following equation (1).

sM=1−fM*dM^{T} (1)

That is, the similarity matrix sM includes a cosine distance between the machining shape feature vector 222 of each image data 221 of the estimation target component and the machining shape feature vector 210 of each teacher data 203 in the teacher data DB 133. In the above equation (1) for calculating the similarity matrix sM, “*” represents matrix multiplication and superscript “T” represents matrix transposition. In the equation (1), it is to be noted that it is assumed that the machining shape feature vector is normalized.

Next, the similarity calculation circuit 127 calculates a similarity vector sV by performing a reduction operation on the similarity matrix sM (step S83). This similarity vector sV has the same length as the total number of teacher data 203 stored in the teacher data DB 133 and the j-th element of the similarity vector sV stores a distance between the estimation target component and the j-th teacher data 203 in the teacher data DB 133. Here, the distance between image data 221i and teacher data 203j is defined as the minimum cosine distance between a machining shape feature vector 222 corresponding to the image data 221i and a machining shape feature vector 210 corresponding to all image data 201 of the teacher data 203j. The image data 221i is the i-th image data 221 of the estimation target component and the teacher data 203j is the j-th teacher data 203 in the teacher data DB 133. The distance between the estimation target component and the teacher data 203j is defined as the sum over all distances between the image data 221 of the estimation target component and the image data 201 of the teacher data 203 j.

Next, the similarity calculation circuit 127 removes teacher data 203 that does not satisfy the dimensional criteria based on the dimensional information to narrow down the options (step S84). Then, the similarity calculation circuit 127 outputs IDs of the N most similar teacher data 203 among the teacher data 203 selected as similar (step S85), and ends the process. Here, the first selected teacher data 203 is the teacher data 203 having the minimum distance (that is, the closest similarity) to the estimation target component.

[Effects]

As described above, the component estimation program according to the present embodiment causes a computer to execute a process for extracting a feature vector of an estimation target component based on a first learning model and image data of the estimation target component. Here, the first learning model is a learning model in which component image data and component transaction data are created as one set of teacher data. Further, the component estimation program causes the computer to execute a process of estimating transaction data of the estimation target component based on the second learning model, the feature vector of the estimation target component, and the specification of the estimation target component. Here, the second learning model is a learning model in which the component feature vector extracted based on the first learning model, the component specification and the component transaction data are created as one set of teacher data. Thus, as compared with a case where the user sets a component shape feature, it is possible to sufficiently set the component shape feature and hence to estimate the component with high precision. In addition, as compared with a case where one step of deep learning is executed using teacher data associating image data of various components with the specifications and transaction data of the components, it is possible to create a highly precise learning model and hence to estimate the components with high precision.

Further, in the component estimating program according to the present embodiment, the extracting process extracts an estimation target component feature vector from a plurality of first learning models based on the first learning model adapted to the estimation target component. Further, in the component estimating program, the estimating process estimates an estimation target component transaction data from a plurality of second learning models based on the second learning model adapted to the estimation target component. Thus, it is possible to estimate various components based on learning models adapted to the components and hence to estimate the components with high precision.

Further, in the component estimation program according to the present embodiment, the estimating process causes the computer to select the second learning model having high similarity of the feature vector as the second learning model adapted to the estimation target component. Thus, it is possible for the user to select a learning model adapted to the estimation target component without special consciousness.

Further, in the component estimation program according to the present embodiment, the estimating processing causes the computer to select the second learning model adapted to the estimation target component based on an estimation target component shape category selected by the user and transaction data to be estimated. Thus, it is possible to select a learning model adapted to the estimation target component without imposing a heavy burden on the user.

Further, in the component estimation program according to present embodiment, the estimation process causes the user to select the second learning model adapted to the estimation target component. Thus, when the user knows a learning model adapted to the estimation target component, it is possible to estimate the components based on the learning model.

[System]

Among all the processes described in the embodiment, all or some of the processes described as being automatically performed may be manually performed. Alternatively, all or some of the processes described as being manually performed may be automatically performed according to a known method. In addition, the processing procedures, control procedures, specific names, and information including various data and parameters illustrated in the specification and the drawings may be arbitrarily changed unless otherwise specified.

In addition, the constituent elements of each device illustrated in the drawings are functionally conceptual and do not necessarily have to be physically constructed as illustrated. That is, the specific forms of distribution and integration of devices are not limited to those illustrated in the drawings. In other words, all or some thereof may be functionally or physically distributed/integrated in arbitrary units depending on various loads, usage conditions and the like. For example, a processing unit (the DL model creation circuit 123, the estimation learning model creation circuit 125, etc.) that performs a process of creating the estimation learning model 132 and a processing unit (the estimation circuit 126, etc.) that performs a process of estimating the estimate target component may be distributed functionally or physically. Further, all or some of the processing functions performed in the devices may be implemented by a CPU and a program analyzed and executed by the CPU, or may be implemented as hardware by wired logic.

[Component Estimation Program]

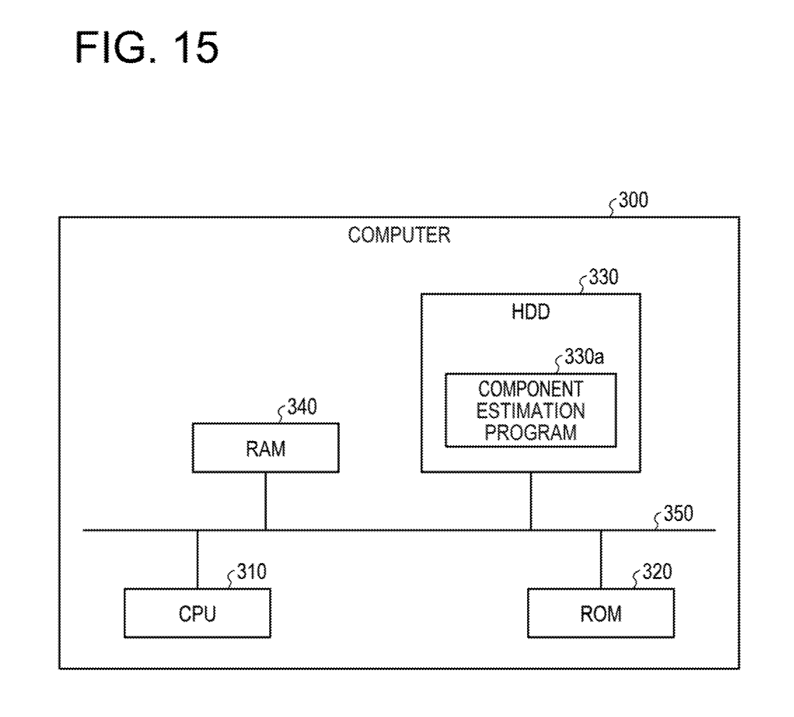

The various processes of the information processing apparatus 100 described in the above embodiments can also be implemented by executing a prepared program on a computer system such as a personal computer or a workstation. Therefore, in the following description, an example of a computer that executes a component estimation program having the same function as the information processing apparatus 100 described in the above embodiments will be described with reference to FIG. 15. FIG. 15 is a view illustrating a computer that executes the component estimating program.

As illustrated in FIG. 15, the computer 300 includes a CPU 310, a ROM 320, an HDD 330 and a RAM 340. These devices 310 to 340 are interconnected via a bus 350.

A basic program such as an OS (Operating System) or the like is stored in the ROM 320. A component estimation program 330a that exhibits the same functions as the reception circuit 121, the image conversion circuit 122, the DL model creation circuit 123, the feature vector extraction circuit 124, the estimation learning model creation circuit 125 and the estimation circuit 126 illustrated in the above embodiments is stored in advance in the HDD 330. The component estimation program 330a may be appropriately divided. Various data and various tables stored in the memory 130 are provided in the HDD 330.

The CPU 310 reads and executes the component estimation program 330a from the HDD 330.

Then, the CPU 310 reads various data and various tables and stores them in the RAM 340. The CPU 310 uses various data and various tables stored in the RAM 340 to execute the component estimation program 330a. All the data stored in the RAM 340 may not be always stored in the RAM 340. Data to be used for processing may be stored in the RAM 340.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store a first set of teacher data including image data of a component and transaction data of the component and a second set of teacher data including a specification of the component and the transaction data of the component; and
a processor coupled to the memory and configured to,
create a first learning model with image data of the component and transaction data of the component as the first set of teacher data,
create a second learning model with a feature vector of the component extracted based on the first learning model, the specification of the component and the transaction data of the component, as the second set of teacher data,
extract a feature vector of an estimation target component based on the first learning model and image data of the estimation target component, and
estimate transaction data of the estimation target component based on the second learning model, the feature vector of the estimation target component, and a specification of the estimation target component.

2. The information processing apparatus according to claim 1, comprising:
the processor configured to execute a deep learning using a multilayered deep layer neural network as a model and create the first learning model with the first set of teacher data, execute a machine learning using the second set of teacher data and create the second learning model with the second set of teacher data.

3. The information processing apparatus according to claim 2, comprising:
the processor configured to extract the feature vector of the estimation target component, based on the first learning model corresponding to a component shape category and a component estimation target from among a plurality of first learning models, and estimate transaction data of the estimation target component, based on the second learning model corresponding to the component shape category and the component estimation target from among a plurality of second learning models.

4. The information processing apparatus according to claim 2, wherein the processor selects the second learning model having high similarity of the feature vector as the second learning model adapted to the estimation target component.

5. The information processing apparatus according to claim 2, wherein the processor selects the second learning model adapted to the estimation target component based on a shape category of the estimation target component selected by a user and the transaction data to be estimated.

6. The information processing apparatus according to claim 2, wherein the processor causes a user to select the second learning model adapted to the estimation target component.

7. A component estimation method that is executed by a computer, the method comprising:
generating a first learning model based on image data of a component and transaction data of the component as a first set of teacher data;
extracting a first feature vector of the component based on the first learning model;
generating a second learning model based on specification of the component and transaction data of the component as a second set of teacher data;
extracting a second feature vector of an estimation target component based on the first learning model and image data of the estimation target component; and
estimating transaction data of the estimation target component based on the second learning model, the second feature vector of the estimation target component and a specification of the estimation target.

8. The component estimation method according to claim 7, the method comprising:
executing a deep learning using a multilayered deep layer neural network as a model and creating the first learning model with the first set of teacher data; and
executing a machine learning using the second set of teacher data and create the second learning model with the second set of teacher data.

9. The component estimation method according to claim 7, wherein the extracting includes extracting a feature vector of the estimation target component from a plurality of first learning models, based on the first learning model adapted to the estimation target component, and
the estimating includes estimating transaction data of the estimation target component from a plurality of second learning models, based on the second learning model adapted to the estimation target component.

10. The component estimation method according to claim 7, wherein the estimating includes causing the computer to select the second learning model having high similarity of the feature vector as the second learning model adapted to the estimation target component.

11. The component estimation method according to claim 7, wherein the estimating includes causing the computer to select the second learning model adapted to the estimation target component based on a shape category of the estimation target component selected by a user and the transaction data to be estimated.

12. The component estimation method according to claim 7, wherein the estimating includes causing a user to select the second learning model adapted to the estimation target component.

13. A non-transitory computer-readable recording medium having stored therein a program for causing a computer to execute a process, the process comprising:
generating a first learning model based on image data of a component and transaction data of the component as a first set of teacher data;
extracting a first feature vector of the component based on the first learning model;
generating a second learning model based on specification of the component and transaction data of the component as a second set of teacher data;
extracting a second feature vector of an estimation target component based on the first learning model and image data of the estimation target component; and
estimating transaction data of the estimation target component based on the second learning model, the second feature vector of the estimation target component and a specification of the estimation target.
